(19) United States
(12) Patent Application Publication
(10) Pub. No.: US 2013/0254705 A1
(43) Pub. Date: Sep. 26, 2013

(54) MULTI-AXIS USER INTERFACE FOR A TOUCH-SCREEN ENABLED WEARABLE DEVICE

(71) Applicants: David J. Mooring, Los Altos Hills, CA (US); Morgan Tucker, San Francisco, CA (US); Timothy D. Twerdahl, Los Altos, CA (US)

(72) Inventors: David J. Mooring, Los Altos Hills, CA (US); Morgan Tucker, San Francisco, CA (US); Timothy D. Twerdahl, Los Altos, CA (US)

(73) Assignee: WIMM LABS, INC., Los Altos, CA (US)

(21) Appl. No.: 13/425,355

(22) Filed: Mar. 20, 2012

(51) Int. Cl. G06F 3/048

(52) U.S. Cl. 715/784

(57) ABSTRACT

A touchscreen-enabled wearable computer includes a multi-axis user interface provided by at least one software component executing on a processor. The multi-axis user interface comprises at least two user interface regions displayed on the touchscreen one at a time, each displaying a series of one or more application screens; and a combination of a vertical navigation axis and a horizontal navigation axis, wherein the vertical navigation axis enables a user to navigate between the multiple user interface regions in response to vertical swipe gestures made on the touchscreen, and the horizontal navigation axis enables the user to navigate the application screens of a currently displayed user interface region in response to horizontal swipe gestures across the touchscreen.

### BACKGROUND

Electronic data and communication devices continue to become smaller, even as their information processing capacity continues to increase. Current portable communication devices are primarily touchscreen-based user interfaces, which allow the devices to be controlled with user finger gestures. Many of these user interfaces are optimized for pocket-sized devices, such as cell phones, that have larger screens typically greater than 3″ or 4″ diagonal. Due to their relatively large form factors, one or more mechanical buttons is typically provided to support operation of these devices.

For example, the user interface of the touchscreen equipped iPhone™ is based around the concept of a home screen displaying an array of available application icons. Depending on the number of applications loaded on the iPhone, the home screen may comprise several pages of icons, with the first being the main home screen. A user may scroll from one home screen page to another of by horizontally swiping a finger across the touchscreen. A tap on one of the icons opens the corresponding application. The main home screen can be accessed from any open application or another home screen page by pressing a hardware button located below the touchscreen, sometimes referred to a home button. To quickly switch between applications, the user may double-click the home button to reveal a row of recently used applications that the user may scroll through with horizontal swipes and then reopen a selected application with a finger tap. Due to the use of horizontal swipes, the user interface of the iPhone can be described as having horizontal-based navigation. While touch-based user interfaces, such as the iPhone's, may offer many advantages, such touch-based user interfaces rely on a complex combination of button presses, finger swipes and taps to navigate and enter/exit applications. This requires the user to focus on the device and visually target the desired function to operate the device.

As rapid advancements in miniaturization occur, much smaller form factors that allow these devices to be wearable become possible. A user interface for a much smaller, wearable touchscreen device, with screen sizes less than 2.5″ diagonal, must be significantly different, in order to provide an easy to use, intuitive way to operate such a small device.

Accordingly, it would be desirable to provide an improved touchscreen-based user interface, optimized for very small wearable electronic devices, that enables a user to access and manipulate data and graphical objects in a manner that reduces the need for visual focus during operation and without the need for space consuming mechanical buttons.

### BRIEF SUMMARY

The exemplary embodiment provides methods and systems for providing a touchscreen-enabled wearable computer with a multi-axis user interface. Aspects of exemplary embodiment include providing the multi-axis user interface with at least two user interface regions that are displayed on the touchscreen one at a time, each displaying a series of one or more application screens; and a combination of a vertical navigation axis and a horizontal navigation axis, wherein the vertical navigation axis enables a user to navigate between the multiple user interface regions in response to vertical swipe gestures made on the touchscreen, and the horizontal navigation axis enables the user to navigate the application screens of a currently displayed user interface region in response to horizontal swipe gestures across the touchscreen.

According to the method and system disclosed herein, using multi-axis navigation, rather than single axis navigation, enables a user to invoke a desired function on the wearable computer with a couple of vertical and horizontal finger swipes (gross gestures), rather than finely targeted finger taps, and minimal focus.

### BRIEF DESCRIPTION OF SEVERAL VIEWS OF THE DRAWINGS

FIG. 1 is block diagram illustrating exemplary embodiments of a wearable computer.

FIG. 2 is a high-level block diagram illustrating computer components comprising the wearable computer according to an exemplary embodiment.

FIGS. 3A, 3B and 3C are a diagram illustrating one embodiment for a multi-axis user interface for the wearable device.

FIG. 4 is a flow diagram illustrating the process for providing a multi-axis user interface for the wearable computer in further detail.

FIG. 5 is a diagram illustrating one embodiment where the start page application comprises a watch face.

FIG. 6 is a diagram illustrating a vertical transition from the start page application on the top level region to the application launcher screen on the middle level region in response to a vertical swipe gesture.

FIG. 7 is a diagram illustrating horizontal scrolling of different application icons from the application launcher.

FIG. 8 is a diagram illustrating a vertical transition from the application launcher screen on the middle level region to an application screen on the bottom level region.

FIG. 9 is a diagram showing an example application screen of a weather application.

FIG. 10 is a diagram showing a vertical transition from the example weather application screen back to the start page application in response to a universal gesture, such as a double finger swipe.

### DETAILED DESCRIPTION

The exemplary embodiment relates to a multi-axis user interface for a wearable computer. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments provide methods and systems for displaying a multi-axis user interface for a touchscreen-enabled wearable computer. The user interface comprises two or more user interface regions where only one of the user interface regions is displayed on the touchscreen at any given time, and a combination of a vertical navigation axis and a horizontal navigation axis. In one embodiment, the vertical navigation axis enables a user to navigate between the user interface regions in response to vertical swipe gestures on the touchscreen. The horizontal navigation axis enables the user to navigate between one or more application screens in each of the user interface regions using horizontal swipe gestures.

A combination of the vertical and horizontal navigation axes simplifies the user interface, enables a user to quickly access a desired application or function, and requires no need for a hardware button for navigation. Consequently, using a series of finger swipes, the user may have minimal need to look at the wearable computer when invoking a desired function.

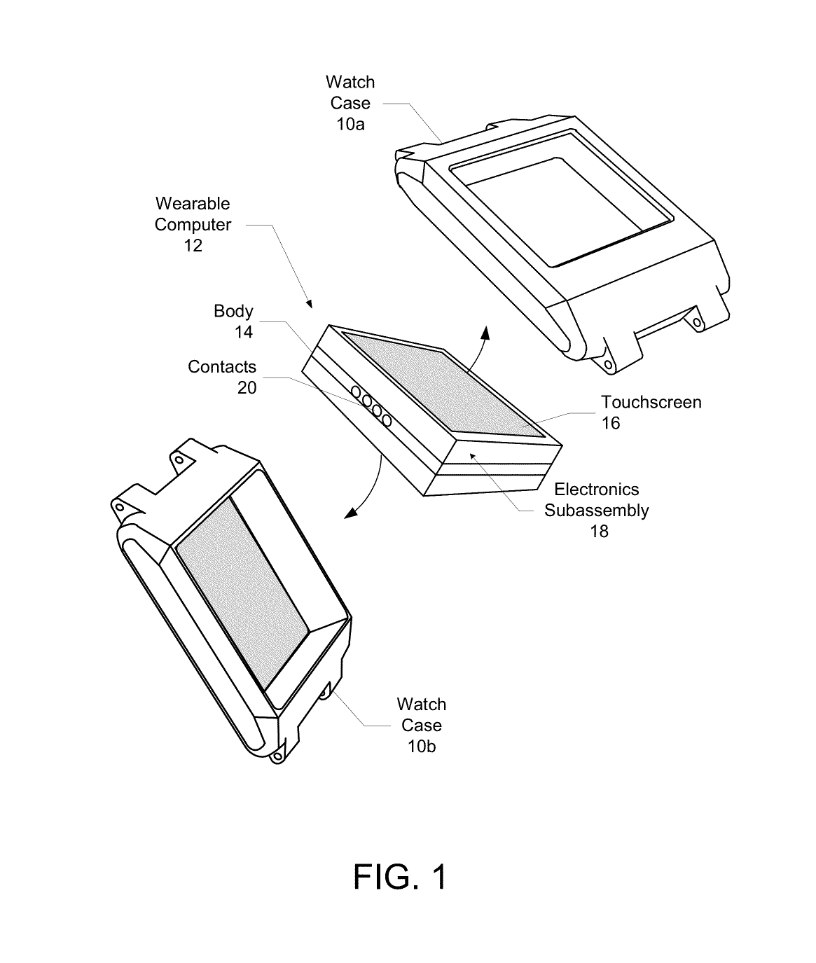

FIG. 1 is block diagram illustrating exemplary embodiments of a wearable computer. According to the exemplary embodiments, the wearable computer 12 is fully functional in a standalone state, but may be interchangeable between accessory devices by physically plugging into form factors as diverse as watchcases and lanyards, for instance. The example of FIG. 1 shows two embodiments. In one embodiment, the wearable computer 12 may be inserted into the back of a watch case 10a. While the other embodiment, shows that the wearable computer 12 may be inserted into the back of another watch case 10b that has a closed back. Watch cases 10a and 10b will be collectively referred to as watch case 10.

In one embodiment, a body 14 of the wearable computer 12 combines components such as a high-resolution touch-screen 16 and a subassembly of electronics 18, such as Bluetooth and WiFi for wireless communication, and a motion sensor (not shown). The wearable computer 12 displays timely relevant information at a glance from onboard applications and web services. The wearable computer 12 also may be considered a companion device to smartphones by relaying information, such as text, emails and caller ID information, from the smartphones, thereby reducing the need for a user to pull out their smartphone from a pocket, purse or briefcase to check status.

In one embodiment, the touchscreen has a size of less than 2.5 inches diagonal, and in some embodiments may be approximately 1.5 inches diagonal. For example, in an exemplary embodiment, the touchscreen 16 may measure 25.4×25.4 MM, while the body 14 of the wearable computer 12 may measure 34×30 MM. According to an exemplary embodiment, the wearable computer 12 has no buttons to control the user interface. Instead, the user interface of the wearable computer 12 is controlled entirely by the user interacting with the touchscreen 16 through touch, such that a button or a dial for controlling the user interface are completely absent from both the wearable computer 12, thereby simplifying user interface and saving manufacturing costs. In one embodiment, a button may be provided on the side of the wearable computer 12 for turning-on and turning-off the wearable computer 12, but not for controlling user interface. In an alternative embodiment, the modular movement 12 may be automatically turned-on when first plugged-in to be recharged.

In a further embodiment, the user interface may be provided with auto configuration settings. In one auto configuration embodiment, once the wearable computer 12 is inserted into the case 10, the wearable computer 12 may be configured via contacts 20 and a corresponding set of contacts on the case 10 to automatically determine characteristics of the case 10, such as the make and model of the case 10. Using the characteristics of the case 10, the wearable computer 12 may automatically configure its user interface accordingly. For example, if the wearable computer 12 is inserted into case 10 and determines that case 10 is an athletic accessory, then the wearable computer 12 may configure its user interface to display an athletic function such as heart rate monitor. And by determining which one of several manufacturers (e.g., Nike™, Under Armor™, and the like) provided the accessory, the wearable computer 12 may display a graphics theme and logo of that manufacturer or automatically invoke a manufacturer-specific application designed for the accessory.

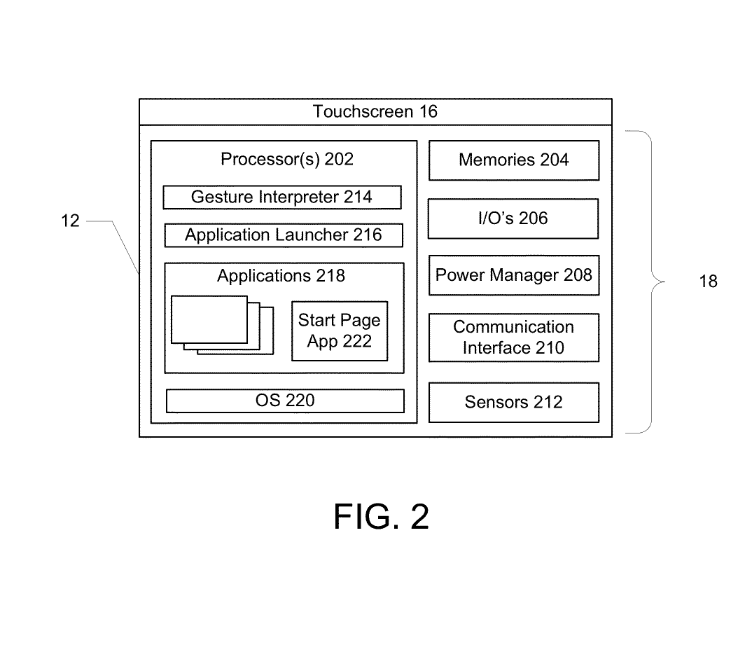

FIG. 2 is a high-level block diagram illustrating computer components comprising the wearable computer 12 according to an exemplary embodiment. Besides the touchscreen 16, the electronics subassembly 18 of the wearable computer 12 may include components such as processors 202, memories 204, inputs/outputs 206, a power manager 208, a communications interface 210, and sensors 212.

The processors 202 may be configured to concurrently execute multiple software components to control various processes of the wearable computer 12. The processors 202 may comprise a dual processor arrangement, such as a main application processor and an always on processor that takes over timekeeping and touchscreen 16 input when the main application processor enters sleep mode, for example. In another embodiment, the processors 202 may comprise at least one processor having multiple cores.

Memories 204 may include a random access memory (RAM) and a nonvolatile memory (not shown). The RAM may be used as the main memory for microprocessor for supporting execution of the software routines and other selective storage functions. The non-volatile memory may hold instructions and data without power and may store the software routines for controlling the wearable computer 12 in the form of computer-readable program instructions. In one embodiment, non-volatile memory comprises flash memory. In alternative embodiments, the non-volatile memory may comprise any type of read only memory (ROM).

I/Os 206 may include components such as a touchscreen controller, a display controller, and an optional audio chip (not shown). The touch controller may interface with the touchscreen 16 to detect touches and touch locations and pass the information on to the processors 202 for determination of user interactions. The display controller may access the RAM and transfer processed data, such as time and date and/or a user interface, to the touchscreen 16 for display. The audio chip may be coupled to an optional speaker and a microphone and interfaces with the processors 202 to provide audio capability for the wearable computer 12. Another example I/O 206 may include a USB controller.

Power manager 208 may communicate with the processors 202 and coordinate power management for the wearable computer 12 while the computer is drawing power from a battery (not shown) during normal operations. In one embodiment, the battery may comprise a rechargeable, lithium ion battery or the like, for example.

The communications interface 210 may include components for supporting one-way or two-way wireless communications. In one embodiment, the communications interface 210 is for primarily receiving data remotely, including streaming data, which is displayed and updated on the touchscreen 16. However, in an alternative embodiment, besides transmitting data, the communication interface 216 could also support voice transmission. In an exemplary embodiment, the communications interface 210 supports low and intermediate power radio frequency (RF) communications. The communications interface 210 may include one or more of a Wi-Fi transceiver for supporting communication with a Wi-Fi network, including wireless local area networks (WLAN), and WiMAX; a cellular transceiver for supporting communication with a cellular network; Bluetooth transceiver for low-power communication according to the Bluetooth protocol and the like, such as wireless personal area networks (WPANs); and passive radio-frequency identification (RFID). Others wireless options may include baseband and infrared, for example. The communications interface 210 may also include other types of communications devices besides wireless, such as serial communications via contacts and/or USB communications, for example.

Sensors 212 may include a variety of sensors including a global positioning system (GPS) chip and an accelerometer (not shown). The accelerometer may be used to measure information such as position, motion, tilt, shock, and vibration for use by processors 202. The wearable computer 12 may additionally include any number of optional sensors, including environmental sensors (e.g., ambient light, temperature, humidity, pressure, altitude, etc), biological sensors (e.g., pulse, body temperature, blood pressure, body fat, etc.), and a proximity detector for detecting the proximity of objects. The wearable computer 12 may analyze and display the information measured from the sensors 212, and/or transmit the raw or analyzed information via the communications interface 210.

The software components executed by the processors 202 may include a gesture interpreter 214, an application launcher 216, multiple software applications 218, and an operating system 220. The operating system 220 is preferably a multitasking operating system that manages computer hardware resources and provides common services for the applications 218. In one embodiment, the operating system 220 may comprise a Linux-based operating system for mobile devices, such as Android™. In one embodiment, the applications 218 may be written in a form of Java and downloaded to the wearable computer 12 from third-party Internet sites or through online application stores. In one embodiment a primary application that controls the user interface displayed on the wearable computer 12 is the application launcher 216.

The application launcher 216 may be invoked by the operating system 220 upon device startup and/or wake from sleep mode. The application launcher 216 runs continuously during awake mode and is responsible for launching other applications 218. In one embodiment, the default application that is displayed by the application launcher is a start page application 222. In one embodiment, the start page application 222 comprises a dynamic watch face that displays at least the time of day but may display other information, such as current location (e.g., city), local weather and date, for instance. In one embodiment, all the applications 218 including the start page application 222 may comprise multiple screens or pages that can be displayed at any given time.

A user operates the wearable computer 12 by making finger gestures using one or more fingers or on the touchscreen 16. A stylus in place of a finger could also be used. The operating system 220 may detect the finger/stylus gestures, termed gesture events, and pass the gesture events to the application launcher 216. The application launcher 216, in turn, may call the gesture interpreter 214 to determine the gesture type (e.g. a vertical swipe, a tap, a tap and hold, etc.). The application launcher 216 may then change the user interface based upon the gesture type.

Although the operating system 220, the gesture interpreter 214 and the application launcher 216 are shown as separate components, the functionality of each may be combined into a lesser or greater number of modules/components.

According to an exemplary embodiment, the application launcher 216 is configured to display a multi-axis user interface comprising multiple user interface regions in combination with both vertical and horizontal navigation axes. The user may navigate among the user interface regions using simple finger gestures made along the orientation of the vertical and horizontal navigation axes to reduce the amount of visual focus required by a user to operate the wearable computer 12. The multi-axis user interface also enables the user to operate the wearable computer 12 without the need for a mechanical button.

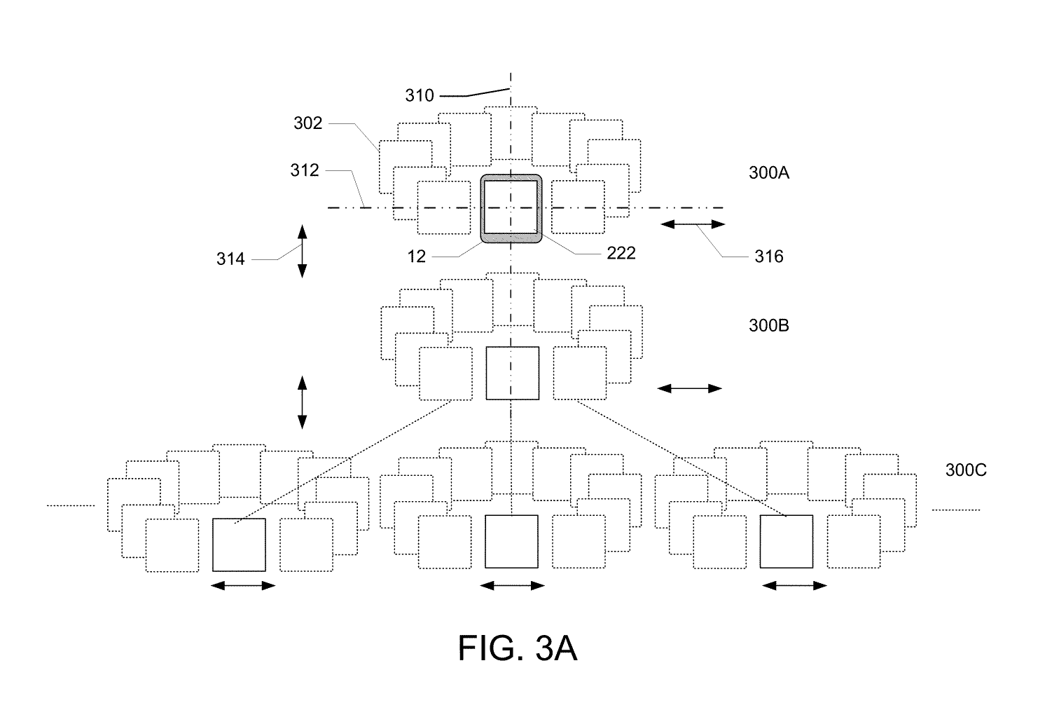

FIGS. 3A, 3B and 3C are a diagram illustrating one embodiment for a multi-axis user interface for the touchscreen-enabled wearable device 12. According to an exemplary embodiment, the multi-axis user interface comprises multiple user interface regions 300A, 300B, 300C (collectively referred to as user interface regions 300). The multiple user interface regions 300 may include a top level region 300A that displays a first series of one or more application screens, a middle level region 300B that displays a second series of application screens, and a bottom level region 300C that displays a third series of one or more application screens. In one embodiment, only one of the regions 300A, 300B, 300C is viewable on the touchscreen 12 at a time except for embodiments where transitions between the regions are animated.

The application launcher 212 is configured to provide a combination of a vertical navigation axis 310 and a horizontal navigation axis 312. In one embodiment, the vertical navigation axis 310 enables a user to navigate between the user interface regions 300A-300C in response to making vertical swipe gestures 314 on the touchscreen 12. That is, in response to detecting a single vertical swipe gesture 314 on a currently displayed user interface level region 300, an immediately adjacent user interface level region 300 is displayed.

The horizontal navigation axis 312, in contrast, is used to display one or more application screens in each of the user interface regions 300 and to enable the user to navigate between the application screens of a currently displayed user interface region using horizontal swipe gestures 316 across the touchscreen. In response to detecting a single horizontal swipe gesture 316 on a currently displayed application screen of a particular user interface level region 300, an immediately adjacent application screen of that user interface level region 300 is displayed.

In one embodiment, during vertical navigation between the user interface regions 300, once the user reaches the top level region 300A or the bottom level region 300C, the user interface is configured such that the user must perform a vertical user swipe 314 in the opposite direction to return to the previous level. In an alternative embodiment, the user interface could be configured such that continuous vertical scrolling through the user interface regions 300A-300C is possible, creating a circular queue of the user interface regions 300A-300C.

In one embodiment, the user interface regions 300A, 300B, 300C can be analogized to regions of an electronic map. A user may navigate an electronic map by placing a finger on the screen and “dragging” the map around in any 360° direction, e.g., moving the finger up “drags” the map upwards with a smooth scroll motion, revealing previously hidden portions of the map. In the current embodiments, the user does not “drag” the user interface regions to reveal the next user interface region, as this would require the user to carefully look at the touchscreen to guide the next region onto the screen. Instead the user navigates between regions with simple vertical swipes, e.g., an up swipe, causing discrete transitions between the user interface regions 300A, 300B, 300C, i.e., the immediately adjacent region “snaps” into place and replaces the previously displayed region.

FIG. 3A shows one embodiment where the top level region 300A may comprise the start page application 222. The start page application 222 may display a series of one or more watch face screens 302 in response to the horizontal swipe gestures so the user may scroll through the watch face screens 302 and select one to become the default watch screen and change the appearance of the wearable computer 12. In one embodiment, the start page application 222 is the default application that is displayed. In one embodiment, a single horizontal swipe gesture may cause the currently displayed watch face screen to be moved to the left or to the right to reveal a previous or next watch face screen. Continuous scrolling may return to the originally displayed watch face screen, creating a circular queue of watch face screens 302. A selection-type gesture, such as a tap or double tap, may select the currently displayed watch face to become the default start page application 222. In alternative embodiments, the start page application 222 could comprise other information type displays, such as social network feeds, weather, and the like.

FIG. 3B shows that the middle level region 300B may comprise an application launcher screen 304 on the wearable computer 12 that displays a series of one or more application icons 306 in response to user swipes so the user may scroll through the application icons 306 and select one to open. In one embodiment, each application icon 306 is displayed on its own screen. In response to detecting horizontal user swipe gestures made on the touchscreen 12 while displaying the middle level region 300B, the application icons 306 are sequentially displayed. In one embodiment, a single horizontal swipe gesture may cause the currently displayed application icon to be moved to the left or to the right to reveal a previous or next application icon. Continuous scrolling may return to the originally displayed application icon screen, creating a circular queue of application icon screens. A selection-type gesture, such as a tap or swipe, may open the application corresponding to the currently displayed application icon 306.

FIG. 3C shows that the bottom level region 300C may comprise a series of one or more application screens 308 for an opened application. Each application displayed by the application launcher 216 may have its own set of application screens 308. A series of applications screens 308 may be displayed in response to detecting the user performing horizontal swipe gestures to move the currently displayed application screen to the left or to the right to reveal a previous or next application screen 308. Continuous scrolling may return to the originally displayed application screen, creating a circular queue of application screens.

In embodiments shown in FIGS. 3A, 3B and 3C, rather than implementing the user interface regions and the series of applications screens as circular queues, the user interface regions and the series of applications screens may be implemented as a linked list of screens or panels that terminate on each end when scrolling past the first panel or the last panel is not permitted. In this embodiment, if the user tries to flip past the first panel or the last panel with a swipe gesture (so there is no panel to flip to), then the currently displayed panel may begin to move when the user's finger starts moving, but then falls back into place when the user's finger lifts from the touchscreen. In one embodiment, the animation of flipping or falling back into place may include a simulated deceleration, e.g., as the panel gets close to the final stopping point, the panel decelerates to stop, rather than stopping abruptly.

In the present embodiment, the user may switch from one application to another by first returning to the application launcher screen 304 with an up swipe, for example, then swiping left or right to select another application, and then perform a down swipe, for example, to enter the application screen 3080 of the other application. In another embodiment, instead of the user have to go up, left/right, and down to change applications, the user may instead continue with horizontal swipes in the bottom level regions 300C until screens for desired application are shown.

In yet another embodiment, the multi-axis user interface may be implemented with two user interface regions, rather than three user interface regions. In this embodiment, the start page application may be implemented as part of the application launcher screen 304, in which the middle level region 300B becomes the top level. The user may then scroll from the start page application to any other application in the application launcher screen 304 using horizontal swipes.

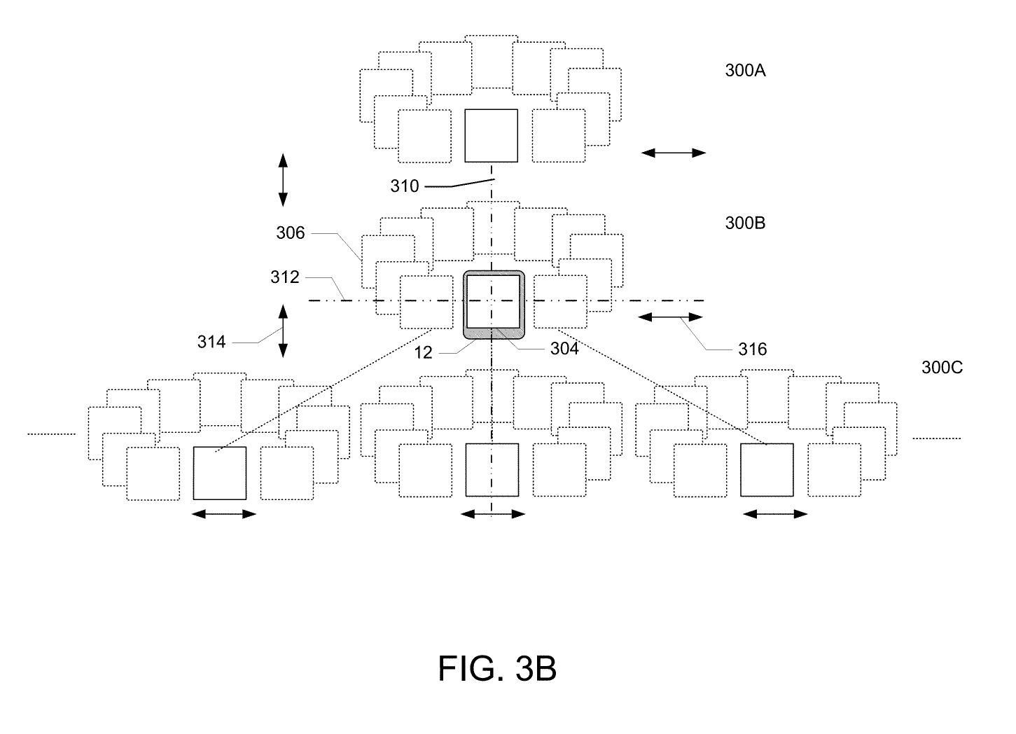

FIG. 4 is a flow diagram illustrating the process for providing a multi-axis user interface for the wearable computer in further detail. In one embodiment, the process may be performed by at least one user interface component executing on the processors 202, including any combination of the gesture interpreter 214, the application launcher 216 and the operating system 220.

The process may begin by displaying on the touchscreen 16 the start page application when the wearable computer 12 starts-up or wakes from sleep (block 400). As described above, the start page application 222 may display a series of one or more watch faces. In one embodiment, the user may horizontally scroll through the series of watch faces by performing horizontal swipe gestures across a currently displayed watch face. In another embodiment, to prevent accidental scrolling, the user may be required to first perform an access-type gesture, e.g., a tap or a tap and hold gesture, on the currently displayed watch face 302 to activate the scrolling feature.

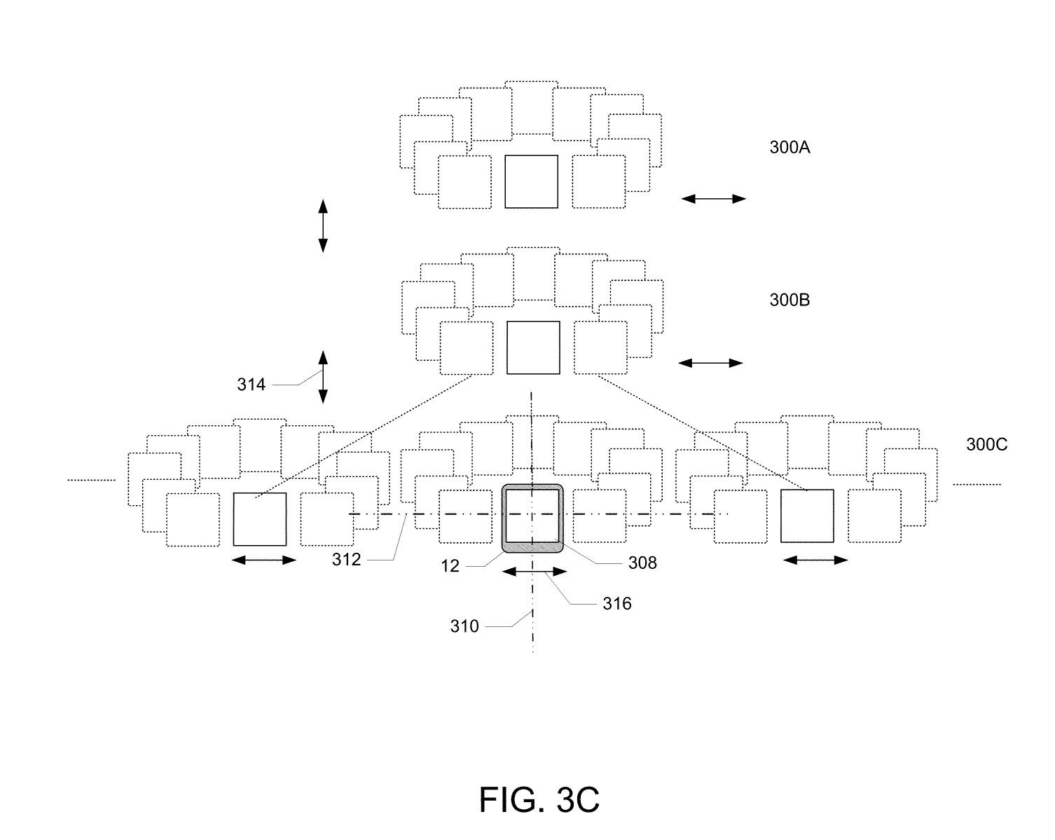

FIG. 5 is a diagram illustrating one embodiment where the start page application 500 comprises a watch face. According to one embodiment, the user may view different watch faces from the start page application 500 in response to left and right horizontal swipe gestures 502. In one embodiment, the horizontal swipe (e.g., left or right) 502 may cause one watch face to replace the currently displayed watch face on the touchscreen 16 with the previous or next watch face. In this embodiment, one watch face comprises an entire page and fills the display of the touchscreen 16, but could be configured to display partial views of adjacent watch faces.

Referring again to FIG. 4, in response to detecting a vertical swipe gesture in a first direction (e.g., up) on the touchscreen while the start page application is displayed, the user interface is transitioned along the vertical axis 310 from the top level region to a middle level region to display the application launcher screen (block 402).

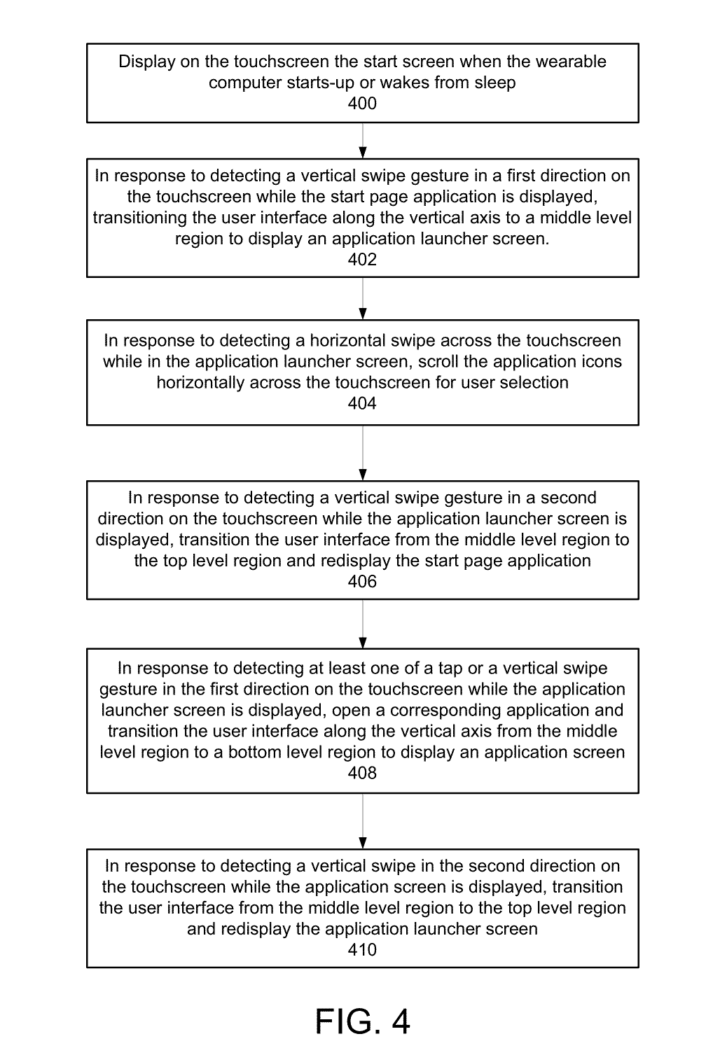

FIG. 6 is a diagram illustrating a vertical transition from the start page application 500 on the top level region to the application launcher screen 602 on the middle level region in response to a vertical swipe gesture 604. The application launcher screen 602 is shown displaying a single application icon, in this case for a weather application. In one embodiment, a single finger up swipe (or down swipe) on the start page application 500 may cause the application launcher screen 602 to simply replace the start page application 500 on the touchscreen 16.

Referring again to FIG. 4, in response to detecting a horizontal swipe gesture across the touchscreen while the application launcher screen is displayed, the application icons are scrolled horizontally across the touchscreen for user selection (block 404).

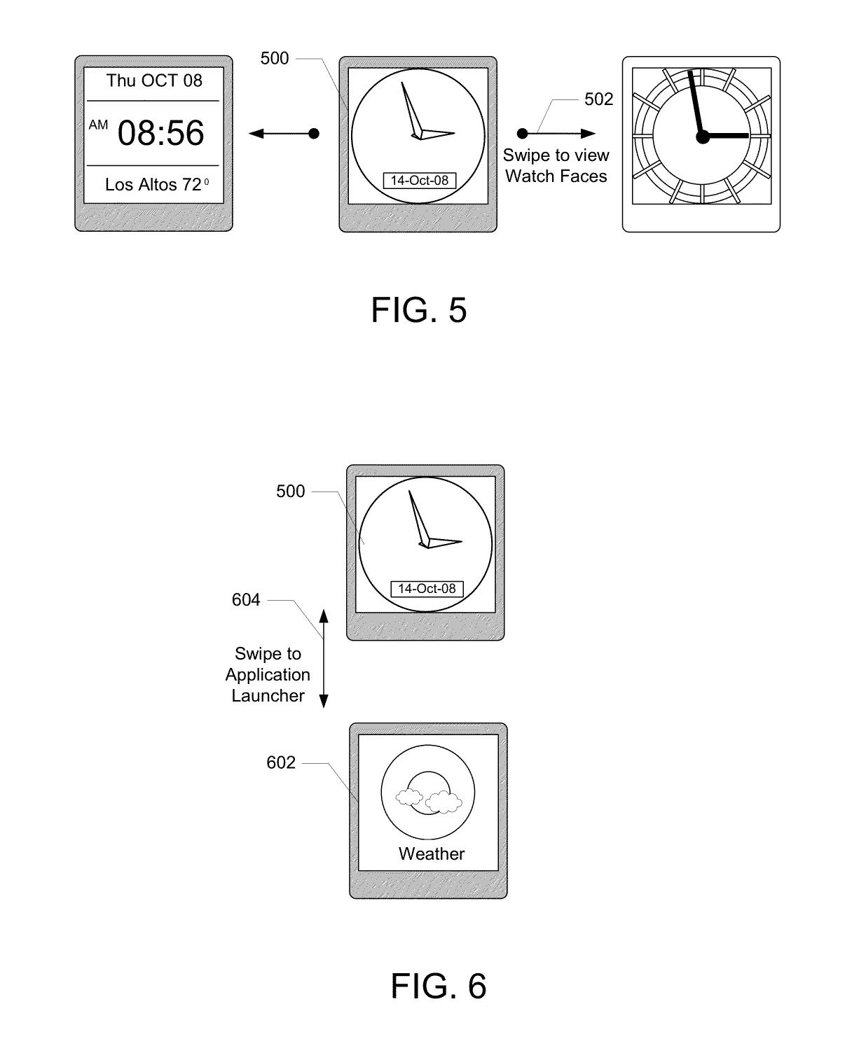

FIG. 7 is a diagram illustrating horizontal scrolling of different application icons 700 from the application launcher in response to left and right horizontal swipe gestures 702. In one embodiment, the horizontal swipe (e.g., left or right) may cause the application launcher 216 to replace the current application icon with the previous or next application icon on the touchscreen 16. In this embodiment, one application icon 700 may comprises an entire page and fills the display of the touchscreen 16, but could be configured to display partial views of adjacent application icons.

Referring again to FIG. 4, in response to detecting a vertical swipe gesture in a second direction (e.g., down) while the application launcher screen 602 is displayed, the user interface transitions from the middle level region 300B to the top level region 300A and redisplays the start page application 500 (block 406).

In response to detecting at least one of a tap or a vertical swipe gesture in the first direction on the touchscreen while the application launcher screen is displayed, a corresponding application is opened and the user interface is transitioned along the vertical axis from the middle level region to a bottom level region to display an application screen (block 408).

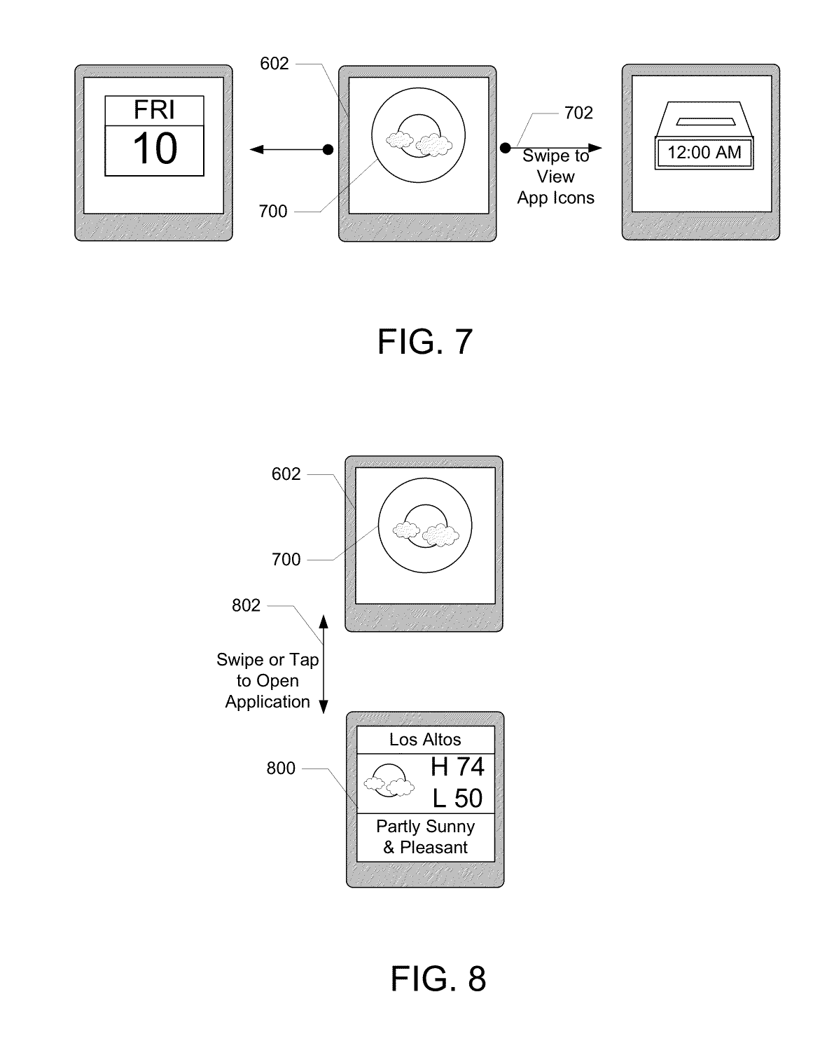

FIG. 8 is a diagram illustrating a vertical transition from the application launcher screen 602 on the middle level region to an application screen 800 on the bottom level region in response to a tap or a vertical swipe gesture 802. In one embodiment, the tap or vertical swipe gesture 802 opens the application by displaying the application screen 800, which may simply replace the selected application icon 700. For example, while the application launcher screen 602 is displayed, a single finger tap or up swipe on the touchscreen may cause the application screen 800 corresponding to the application icon 700 to be displayed.

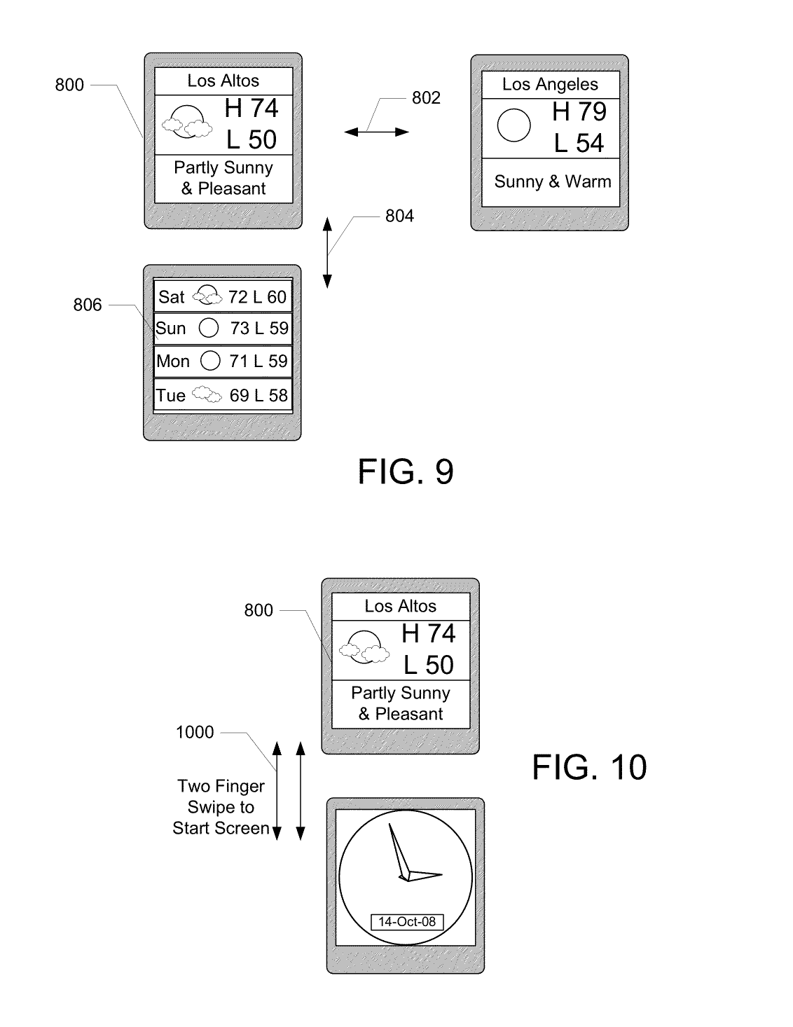

FIG. 9 is a diagram showing an example application screen 800 of a weather application, which was opened in response to the user selecting the weather application icon 700 from the application launcher screen 602. The weather application 800 may comprise several pages, where each page may show the current weather for a different city. The user may scroll from city to city using horizontal swiping gestures 802. In response to the user performing a vertical swipe 804, e.g., an up swipe, the page is pulled up to reveal the weather for each day of the week. In one embodiment, each day of the week may be shown on its own “mini-panel” 806 (e.g., a rectangular subdivision of a page). The mini-panels 806 may occupy the bottom of the application screen 800, or be implemented as a separate page.

Referring again to FIG. 4, in response to detecting a vertical swipe gesture in second direction (e.g., a down) on the touchscreen while the application screen 800 is displayed, the user interface transitions from the bottom level region 300C to the middle level region 300B and redisplays the application launcher screen 602 (block 410).

In an alternative embodiment, in response to detecting a universal gesture while in either the application launcher screen or an application screen for an open application, the home screen is redisplayed. A universal gesture may be gesture that is mapped to the same function regardless of what level or region of the user interface is displayed. One example of such a universal gesture may be a two finger vertical swipe. Once detected from the application launcher or an application, the application launcher causes the redisplay of the start page application, e.g., the watch face.

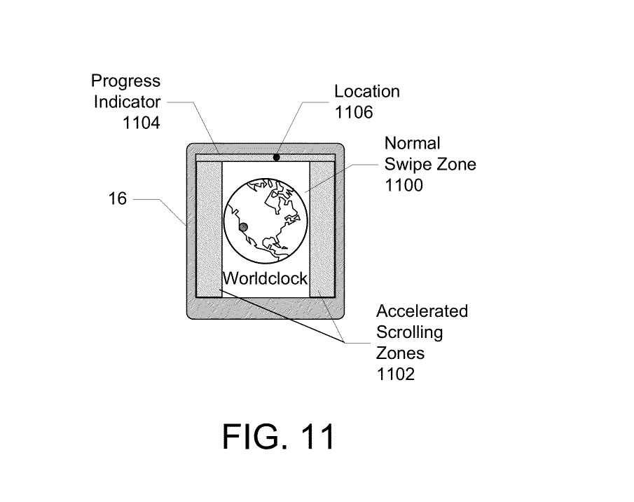

FIG. 10 is a diagram showing a vertical transition from the example weather application screen 800 back to the start page application in response to a universal gesture 1000, such as a double finger swipe. Here the user causes the user interface to jump from the bottom level region 300C to the top level region 300A in one motion.

Referring again to FIGS. 3A-3C, vertical scrolling between the screens of the user interface regions 300A-300C and horizontal scrolling between watch face screens 302, application icons 306, and application screens 308 has been described as a discrete step whereby one screen replaces another during a scrolling transition. In an alternative embodiment, the scrolling may be implemented with flick transition animations where transitions between screens are smoothly animated, such that the currently displayed screen is shown to dynamically scroll off of the display, while the next screen is shown to dynamically scroll onto the display.

In an exemplary embodiment, when the gesture manager 214 (or equivalent code) detects that the user's finger has started sliding vertically or horizontally, the application launcher 216 causes the screen to move up/down or left/right with the movement of the finger in a spring-loaded fashion. When the gesture manager determines that the finger has moved some minimum distance, e.g., 1 cm, and then lifted from the touchscreen, the application launcher 216 immediately displays a fast animation of the screen “flipping” in the same direction of the user's finger, e.g., up/down or left/right. In one embodiment, the flipping animation may be implemented using the Hyperspace animation technique shown in the Android “APIDemos.” If the users finger has not moved the minimum distance before lifting, then the gesture manager determines that the user has not attempted a “flick”. In this case, the screen appears to “fall” back into its original place. While the transition animation may be preferable aesthetically, the discrete transition may consume less battery power.

According to a further aspect of the exemplary embodiments, an area along the edges of the touchscreen 16 may be designated for fast horizontal scrolling. If the user starts sliding a finger along the designated bottom or top edges of the touchscreen 16, the system may consider it a “fast scroll” event, and in response starts rapidly flipping through the series of screens as the user swipes their finger.

FIG. 11 is a block diagram illustrating fast scroll areas on the touchscreen 16. The surface of the touchscreen 16 may be divided into a normal swipe zone 1100 and two accelerated scrolling zones 1102 along the side edges. The gesture manager 214 and application launcher 216 may be configured such that detection of a finger sliding horizontally anywhere within the normal swipe zone 1100 displays the next screen in the series of screens. Detection of other gestures in the accelerated scrolling zones 1102 may cause a continuous and rapid display of screens in the series. For example, a tap and hold of a finger in the accelerated scrolling zones 1102 may cause a continuous, ramped accelerated advancement through the list of screens, while a single tap may advance the screens one at a time.

In a further embodiment, a progress indicator 1104 showing a current location 1106 with the series of screens may appear on the touchscreen 16 as the user's finger remains on the accelerated scrolling zones. If the finger is fast-scrolling along one edge (e.g., bottom or top,) and progress indicator 1104 may be displayed along the other edge.

A method and system for providing a multi-axis user interface for a wearable computer has been disclosed. The present invention has been described in accordance with the embodiments shown, and there could be variations to the embodiments, and any variations would be within the spirit and scope of the present invention. For example, in an alternative embodiment, functions of the vertical and horizontal axes of the wearable computer could be interchanged so that the vertical navigation axis is used to navigate between the application screens using vertical swipes, while the horizontal axis is used to navigate between the user interface regions in response to horizontal swipes. Accordingly, many modifications may be made by one of ordinary skill in the art without departing from the spirit and scope of the appended claims. Software written according to the present invention is to be either stored in some form of computer-readable storage medium such as a memory or a hard disk and is to be executed by a processor.

We claim:

1. A wearable computer, comprising:
a touchscreen having a size of less than 2.5 inches diagonal;
at least one software component executing on a processor configured to display a multi-axis user interface, the multi-axis user interface comprising:
multiple user interface regions displayed on the touchscreen one at a time comprising:
a top level region that displays a first series of one or more application screens,
a middle level region that displays a second series of application screens, and
a bottom level region that displays a third series of one or more application screens; and
a combination of a vertical navigation axis and a horizontal navigation axis, wherein the vertical navigation axis enables a user to navigate between the multiple user interface regions in response to vertical swipe gestures made on the touchscreen, and the horizontal navigation axis enables the user to navigate the application screens of a currently displayed user interface region in response to horizontal swipe gestures across the touchscreen.

2. The wearable computer of claim 1 wherein in response to detecting a single vertical swipe gesture on the currently displayed user interface region, an immediately adjacent user interface region is displayed.

3. The wearable computer of claim 2 wherein during vertical navigation between the user interface regions, once the user reaches the top level region or the bottom level region, the user interface is configured such that the user must perform a vertical user swipe in an opposite direction to return to a previous level.

4. The wearable computer of claim 2 wherein continuous scrolling through the user interface regions returns to an originally displayed user interface region, creating a circular queue of user interface regions.

5. The wearable computer of claim 3 wherein the user interface regions are implemented as a linked list of panels that terminate on each end, wherein scrolling past a first panel or a last panel is not permitted.

6. The wearable computer of claim 1 wherein in response to detecting a single horizontal swipe gesture on a currently displayed application screen of a particular user interface region, an immediately adjacent application screen of that user interface region is displayed.

7. The wearable computer of claim 6 wherein continuous scrolling through the application screens returns to an originally displayed application screen, creating a circular queue of application screens.

8. The wearable computer of claim 6 wherein the application screens are implemented as a linked list of panels that terminate on each end, wherein scrolling past a first panel or a last panel is not permitted.

9. The wearable computer of claim 1 wherein the middle level region comprises an application launcher screen that displays a series of one or more application icons in response to the horizontal swipe gestures so the user may scroll through the application icons and select an application to open.

10. The wearable computer of claim 1 wherein the bottom level region comprises a series of one or more application screens for an opened application.

11. The wearable computer of claim 1 wherein the top level region comprises a start page application that displays a series of one or more watch faces in response to the horizontal swipe gestures so the user may scroll through the watch face screens and select one to become a default watch screen to change an appearance of the wearable computer.

12. The wearable computer of claim 1 further comprises an operating system and a gesture interpreter, wherein the operating system detects gesture events occurring on the touchscreen and passes the gesture events to an application launcher, and wherein the application launcher calls the gesture interpreter to determine a gesture type, and the application launcher changes the user interface based upon the gesture type.

13. A method for providing a multi-axis user interface on a wearable computer by a software component executing on at least one processor of the wearable computer, the method comprising:
displaying on a touchscreen that is less than 2.5 inches diagonal a top level region comprising a start page application;
in response to detecting a vertical swipe gesture in a first direction on the touchscreen while the start page application is displayed, transitioning the user interface along the vertical axis from the top level region to a middle level region to display an application launcher screen;
in response to detecting a horizontal swipe gesture across the touchscreen while in the application launcher screen is displayed, scrolling application icons horizontally across the touchscreen for user selection; and
in response to detecting at least one of a tap or a vertical swipe gesture in the first direction on the touchscreen while the application launcher screen is displayed, opening a corresponding application and transitioning the user interface along the vertical axis from the middle level region to a bottom level region to display an application screen.

14. The method of claim 13 further comprising: in response to detecting a vertical swipe gesture in a second direction on the touchscreen while the application launcher screen is displayed, transitioning the user interface from the middle level region to the top level region to redisplay the start page application.

15. The method of claim 13 further comprising: in response to detecting a vertical swipe gesture in a second direction on the touchscreen while the application screen is displayed, transitioning the user interface along the vertical axis from the middle level region to the top level region to redisplay the application launcher screen.

16. The method of claim 13 further comprising: configuring the start page application as a series of one or more watch faces, and in response to detecting a horizontal swipe across a currently displayed watch face, scrolling the series of one or more watch faces horizontally across the touchscreen for user selection.

17. An executable software product stored on a computer-readable storage medium containing program instructions for providing a multi-axis user interface on a wearable computer, the program instructions for:
displaying on a touchscreen that is less than 2.5 inches diagonal a top level region comprising a start page application;
in response to detecting a vertical swipe gesture in a first direction on the touchscreen while the start page application is displayed, transitioning the user interface along the vertical axis from the top level region to a middle level region to display an application launcher screen;
in response to detecting a horizontal swipe gesture across the touchscreen while in the application launcher screen is displayed, scrolling application icons horizontally across the touchscreen for user selection; and
in response to detecting at least one of a tap or a vertical swipe gesture in the first direction on the touchscreen while the application launcher screen is displayed, opening a corresponding application and transitioning the user interface along the vertical axis from the middle level region to a bottom level region to display an application screen.

18. A user interface for a touchscreen-enabled wearable computer, comprising:
two or more user interface regions where only one of the user interface regions is displayed on the touchscreen at any given time;
a vertical navigation axis that enables a user to navigate between the user interface regions in response to vertical swipe gestures on the touchscreen; and
a horizontal navigation axis that enables the user to display one or more application screens in each of the user interface regions and to enable the user to navigate between the application screens using horizontal swipe gestures.

19. A user interface for a touchscreen-enabled wearable computer, comprising:
two or more user interface regions where only one of the user interface regions is displayed on the touchscreen at any given time;
a horizontal navigation axis that enables a user to navigate between the user interface regions in response to horizontal swipe gestures on the touchscreen; and
a vertical navigation axis that enables the user to display one or more application screens in each of the user interface regions and to enable the user to navigate between the application screens using vertical swipe gestures.
